(19) United States
(12) Patent Application Publication
(10) Pub. No.: US 2021/0157380 A1
(43) Pub. Date: May 27, 2021

(54) REDUCING PROCESSOR POWER CONSUMPTION

(71) Applicant: QUALCOMM Incorporated, San Diego, CA (US)

(72) Inventors: Anubha MOTWANI, Bangalore (IN); Kaustav ROYCHOWDHURY, Bangalore (IN); Siddesh HALAVARTHI MATH REVANA, Bangalore (IN)

(21) Appl. No.: 16/696,073

(22) Filed: Nov. 26, 2019

(51) Int. Cl. G06F 1/324; G06F 1/08; G06F 13/10

(52) U.S. Cl. CPC G06F 1/324; G06F 13/102; G06F 1/08

(57) ABSTRACT

In some aspects, the present disclosure provides a method for scaling a core processor clock to reduce power consumption. The method includes retrieving, by an advanced peripheral bus (APB) driver, a first one or more values from one or more registers of a core processor, the first one or more values corresponding to a set of instructions of the core processor. The method may also include determining, by an IPC calculator, a first expected instruction per cycle (IPC) for executing the set of instructions based on the first one or more values. The method may also include comparing, by the IPC calculator, a threshold IPC to the first expected IPC to determine whether an equality condition is met, wherein the threshold IPC is stored in a first register of the IPC calculator.

### BACKGROUND

### Field of the Disclosure

The teachings of the present disclosure relate generally to processor power consumption, and more particularly, to techniques for reducing processor power consumption according to needs of a particular instruction.

### Description of the Related Art

As capabilities increase and form factor is reduced, processor-based equipment (e.g., system-on-a-chip (SoC)) tends to exhibit more power consumption than legacy equipment. Accordingly, power efficiency for processor-based equipment is becoming increasingly important as processors evolve. Specific considerations are the reduction of thermal effects and energy conservation (e.g., reducing amount of power used during operation). Also, apart from energy conservation, power efficiency is a concern for battery-operated processor-based equipment, where it is desired to minimize battery size so that the equipment can be made small and lightweight.

CPUs may be utilizing higher clock frequencies (which may also require higher voltages and thus higher power consumption) than necessary for certain programs. Software-based techniques have been used to reduce processor power consumption; however, the effectivity of such techniques is generally limited by inefficiencies. For example, software-based solutions cannot efficiently control frequency scaling due to ineffective sampling windows (e.g., the frequency at which data is monitored and the clock frequency is adjusted).

Thus, as the demand for power efficient processor-based equipment continues to increase, there exists a need for further improvements to the technology.

### SUMMARY

The following presents a simplified summary of one or more aspects of the present disclosure, in order to provide a basic understanding of such aspects. This summary is not an extensive overview of all contemplated features of the disclosure, and is intended neither to identify key or critical elements of all aspects of the disclosure nor to delineate the scope of any or all aspects of the disclosure. Its sole purpose is to present some concepts of one or more aspects of the disclosure in a simplified form as a prelude to the more detailed description that is presented later.

Aspects of the disclosure relate to a method for dynamically scaling a clock frequency, the method comprising retrieving, by an advanced peripheral bus (APB) driver, a first one or more values from one or more registers of a core processor, the first one or more values corresponding to a set of instructions of the core processor. The method may also include determining, by an IPC calculator, a first expected instruction per cycle (IPC) for executing the set of instructions based on the first one or more values. The method may also include comparing, by the IPC calculator, a threshold IPC to the first expected IPC to determine whether an equality condition is met, wherein the threshold IPC is stored in a first register of the IPC calculator. If the equality condition is not met, the method may include determining, by the IPC calculator, a first scaling value, scaling, by a clock generator, a clock signal of the core processor according to the first scaling value, executing, by the core processor, the set of instructions using the clock signal scaled according to the first scaling value, and updating, by the core processor, the first one or more values of the one or more registers with a second one or more values. If the equality condition is met, executing, by the core processor, the set of instructions using the clock signal of the core processor.

Aspects of the disclosure relate to an apparatus, comprising: a memory; and a processor communicatively coupled to the memory, the processor configured to: retrieve a first one or more values from one or more registers of a core processor, the first one or more values corresponding to a set of instructions of the core processor. The processor may also be configured to determine a first expected instruction per cycle (IPC) for executing the set of instructions based on the first one or more values, and compare a threshold IPC to the first expected IPC to determine whether an equality condition is met, wherein the threshold IPC is stored in a first register of an IPC calculator. If the equality condition is not met, the processor is further configured to determine a first scaling value, scale a clock signal of the core processor according to the first scaling value, execute the set of instructions using the clock signal scaled according to the first scaling value, and update the first one or more values of the one or more registers with a second one or more values. If the equality condition is met, the processor is further configured to execute the set of instructions using the clock signal of the core processor.

Aspects of the disclosure relate to an apparatus, including means for retrieving a first one or more values from one or more registers of a core processor, the first one or more values corresponding to a set of instructions of the core processor. The apparatus may also include means for determining a first expected instruction per cycle (IPC) for executing the set of instructions first one or more values. The apparatus may also include means for comparing a threshold IPC to the first expected IPC to determine whether an equality condition is met, wherein the threshold IPC is stored in a first register of an IPC calculator. If the equality condition is not met, the apparatus may include means for determining a first scaling value, means for scaling a clock signal of the core processor according to the first scaling value, means for executing the set of instructions using the clock signal scaled according to the first scaling value, and means for updating the first one or more values of the one or more registers with a second one or more values. If the equality condition is met, the apparatus may also include means for executing, by the core processor, the set of instructions using the clock signal of the core processor.

Aspects of the disclosure relate to a non-transitory computer-readable storage medium that stores instructions that when executed by a processor of an apparatus cause the apparatus to perform a method for dynamically scaling a clock frequency, including: retrieving a first one or more values from one or more registers of a core processor, the first one or more values corresponding to a set of instructions of the core processor. The method may also include determining a first expected instruction per cycle (IPC) for executing the set of instructions based on the first one or more values. The method may also include comparing a threshold IPC to the first expected IPC to determine whether an equality condition is met, wherein the threshold IPC is stored in a first register of an IPC calculator. If the equality condition is not met, the method may also include determining a first scaling value, scaling a clock signal of the core processor according to the first scaling value, executing the set of instructions using the clock signal scaled according to the first scaling value, and updating the first one or more values of the one or more registers with a second one or more values. If the equality condition is met, the method may also include executing the set of instructions using the clock signal of the core processor.

Aspects of the present disclosure provide means for, apparatus, processors, and computer-readable mediums for performing techniques and methods for dynamically scaling a clock frequency at processor based equipment.

To the accomplishment of the foregoing and related ends, the one or more aspects comprise the features hereinafter fully described and particularly pointed out in the claims. The following description and the appended drawings set forth in detail certain illustrative features of the one or more aspects. These features are indicative, however, of but a few of the various ways in which the principles of various aspects may be employed.

### BRIEF DESCRIPTION OF THE DRAWINGS

So that the manner in which the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects.

FIG. 1 is a block diagram illustrating an exemplary system-on-chip (SoC) integrated circuit in accordance with certain aspects of the present disclosure.

FIG. 2 is a block diagram illustrating an example hardware configuration for reducing processor power consumption in accordance with certain aspects of the present disclosure.

FIG. 3 is a block diagram illustrating an example implementation of the IPC calculator in accordance with certain aspects of the present disclosure.

FIG. 4 is a block diagram illustrating an example implementation of the DCD calculator in accordance with certain aspects of the present disclosure.

FIG. 5 illustrates an example clock signal waveform in accordance with certain aspects of the present disclosure.

FIG. 6 is a flow diagram illustrating example operations for scaling a system clock of an active core processor in accordance with certain aspects of the present disclosure.

FIG. 7 is a flow diagram illustrating example operations for scaling a system clock of an active core processor in accordance with certain aspects of the present disclosure.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

The various embodiments will be described in detail with reference to the accompanying drawings. Wherever possible, the same reference numbers will be used throughout the drawings to refer to the same or like parts. References made to particular examples and implementations are for illustrative purposes, and are not intended to limit the scope of the invention or the claims.

While features of the present invention may be discussed relative to certain embodiments and figures below, all embodiments of the present invention can include one or more of the advantageous features discussed herein. In other words, while one or more embodiments may be discussed as having certain advantageous features, one or more of such features may also be used in accordance with various other embodiments discussed herein.

The term “system on chip” (SoC) is used herein to refer to a single integrated circuit (IC) chip that contains multiple resources and/or processors integrated on a single substrate. A single SoC may contain circuitry for digital, analog, mixed-signal, and radio-frequency functions. A single SoC may also include any number of general purpose and/or specialized processors (digital signal processors, modem processors, video processors, etc.), memory blocks (e.g., read-only memory (ROM), RAM, Flash, etc.), and resources (e.g., timers, voltage regulators, oscillators, etc.), any or all of which may be included in one or more cores.

A number of different types of memories and memory technologies are available or contemplated in the future, all of which are suitable for use with the various aspects of the present disclosure. Such memory technologies/types include phase change memory (PRAM), dynamic random-access memory (DRAM), static random-access memory (SRAM), non-volatile random-access memory (NVRAM), flash memory (e.g., embedded multimedia card (eMNIC) flash, flash erasable programmable read only memory (FEPROM)), pseudostatic random-access memory (PSRAM), double data rate synchronous dynamic random-access memory (DDR SDRAM), and other random-access memory (RAM) and ROM technologies known in the art. A DDR SDRAM memory may be a DDR type 1 SDRAM memory, DDR type 2 SDRAM memory, DDR type 3 SDRAM memory, or a DDR type 4 SDRAM memory.

Each of the above-mentioned memory technologies include, for example, elements suitable for storing instructions, programs, control signals, and/or data for use in or by a computer or other digital electronic device. Any references to terminology and/or technical details related to an individual type of memory, interface, standard or memory technology are for illustrative purposes only, and not intended to limit the scope of the claims to a particular memory system or technology unless specifically recited in the claim language. Mobile computing device architectures have grown in complexity, and now commonly include multiple processor cores, SoCs, co-processors, functional modules including dedicated processors (e.g., communication modem chips, global positioning system (GPS) processors, display processors, etc.), complex memory systems, intricate electrical interconnections (e.g., buses and/or fabrics), and numerous other resources that execute complex and power intensive software applications (e.g., video streaming applications, etc.).

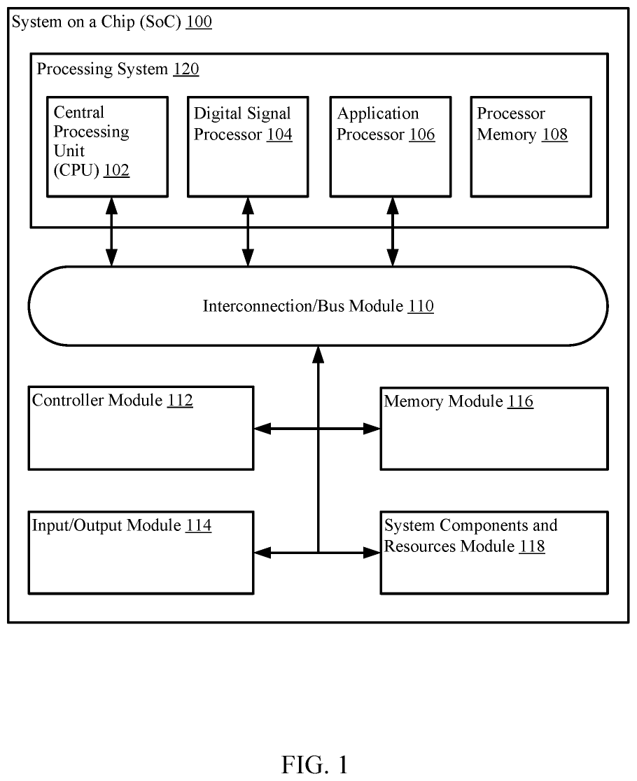

FIG. 1 is a block diagram illustrating an exemplary system-on-chip (SoC) 100 suitable for implementing various aspects of the present disclosure. The SoC 100 includes a processing system 120 that includes a plurality of heterogeneous processors such as a central processing unit (CPU) 102, a digital signal processor 104, an application processor 106, and a processor memory 108. The processing system 120 may include one or more cores, and each processor/core may perform operations independent of the other processors/cores. The processors 102, 104, and 106 may be organized in close proximity to one another (e.g., on a single substrate, die, integrated chip, etc.) so that they may operate at a much higher frequency/clock-rate than would be possible if the signals were to travel off-chip. The proximity of the cores may also allow for the sharing of on-chip memory and resources (e.g., voltage rail), as well as for more coordinated cooperation between cores.

The processing system 120 is interconnected with one or more controller module(s) 112, input/output (I/O) module(s) 114, memory module(s) 116, and system component and resources module(s) 118 via a bus module 110 which may include an array of reconfigurable logic gates and/or implement bus architecture (e.g., CoreConnect, advanced microcontroller bus architecture (AMBA), etc.). Bus module 110 communications may be provided by advanced interconnects, such as high performance networks on chip (NoCs). The interconnection/bus module 110 may include or provide a bus mastering system configured to grant SoC components (e.g., processors, peripherals, etc.) exclusive control of the bus (e.g., to transfer data in burst mode, block transfer mode, etc.) for a set duration, number of operations, number of bytes, etc. In some cases, the bus module 110 may implement an arbitration scheme to prevent multiple master components from attempting to drive the bus simultaneously.

The controller module 112 may be a specialized hardware module configured to manage the flow of data to and from the memory module 116, the processor memory 108, or a memory device located off-chip (e.g., a flash memory device). In some examples, the memory module may include a host device configured to receive various memory commands from multiple masters (e.g., processors and/or other modules), and address and communicate the memory commands to a memory device. The multiple masters may include processors 102, 104, and 106, and/or multiple applications running on one or more of the processors 102, 104, and 106. The controller module 112 may comprise one or more processors configured to perform operations disclosed herein. Examples of processors include microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described throughout this disclosure.

The I/O module 114 is configured for communicating with resources external to the SoC 100. For example, the I/O module 114 includes an input/output interface (e.g., a bus architecture or interconnect) or a hardware design for performing specific functions (e.g., a memory, a wireless device, and a digital signal processor). In some examples, the I/O module 114 includes circuitry to interface with peripheral devices, such as a memory device located off-chip.

The memory module 116 is a computer-readable storage medium implemented in the SoC 100. The memory module 116 may provide one or more of a non-volatile storage (e.g., such as flash memory, ROM, etc.) or volatile storage such as a RAM (e.g., SRAM, DRAM, etc.), for one or more of the processing system 120, controller module 112, I/O module 114, and/or the system components and resources module 118. The memory module 116 may include a cache memory to provide temporary storage of information to enhance processing speed of the SoC 100. In some examples, the memory module 116 may be implemented as a universal flash storage (UFS) integrated into the SoC 100, or an external UFS card.

The SoC 100 may include a system components and resources module 118 for managing sensor data, analog-to-digital conversions, wireless data transmissions, and for performing other specialized operations (e.g., supporting interoperability between different devices). System components and resources module 118 may also include components such as voltage regulators, oscillators, phase-locked loops, peripheral bridges, data controllers, system controllers, access ports, timers, and other similar components used to support the processors and software clients running on the computing device. The system components and resources 118 may also include circuitry for interfacing with peripheral devices, such as cameras, electronic displays, wireless communication devices, external memory chips, etc.

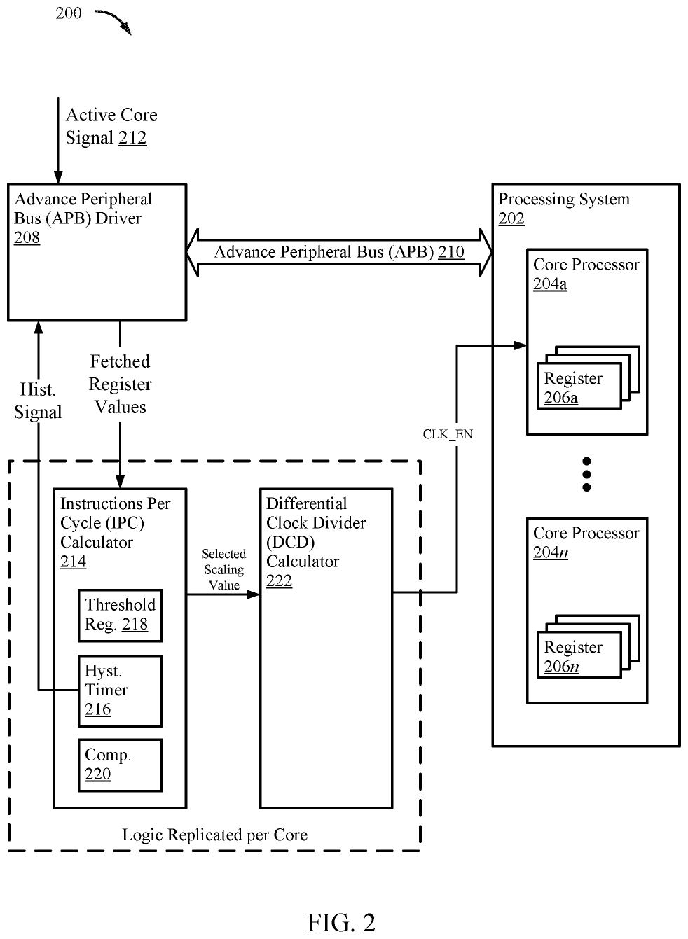

Aspects of the present disclosure are directed to a hardware (HW) based solution for determining an instructions per cycle (IPC) for which a CPU is capable of executing a program, and scaling a clock of the CPU according to the calculated IPC to reduce power consumption. An example hardware implementation of the present disclosure is described in more detail below in reference to FIG. 2.

FIG. 2 is a block diagram illustrating an example hardware configuration 200 for reducing processor power consumption. In accordance with various aspects of the disclosure, an element, or any portion of an element, or any combination of elements may be implemented with a processing system 202 (e.g., processing system 120 of FIG. 1) that includes one or more core processors 204a-204n (e.g., CPU 102, DSP 104, and application processor 106 of FIG. 1). In some examples, the processing system is a multi-core micro-processor.

In various aspects of the disclosure, the hardware configuration 200 may be part of any suitable system-on-a-chip (SoC) (e.g., SoC 100 of FIG. 1), integrated circuit (IC), or other hardware circuit (e.g., mobile station modem (MSM)). In some examples, the hardware configuration 200 may be embodied in a wireless communication device (e.g., base station (BS), a base transceiver station (BTS), a radio base station, a radio transceiver, a transceiver function, a basic service set (BSS), an extended service set (ESS), an access point (AP), a Node B, an eNode B or gNode B (eNB/gNB), mesh node, relay, or some other suitable terminology), or any other suitable device.

In other examples, the hardware configuration 200 may be embodied by a wireless user equipment (UE). Examples of a UE include a cellular phone, a smart phone, a session initiation protocol (SIP) phone, a laptop, a notebook, a netbook, a smartbook, a personal digital assistant (PDA), a satellite radio, a global positioning system (GPS) device, a multimedia device, a video device, a digital audio player (e.g., MP3 player), a camera, a game console, an entertainment device, a vehicle component, a wearable computing device (e.g., a smart watch, a health or fitness tracker, etc.), an appliance, a sensor, a vending machine, or any other similar functioning device. The UE may also be referred to by those skilled in the art as a mobile station (MS), a subscriber station, a mobile unit, a subscriber unit, a wireless unit, a remote unit, a mobile device, a wireless device, a wireless communications device, a remote device, a mobile subscriber station, an access terminal (AT), a mobile terminal, a wireless terminal, a remote terminal, a handset, a terminal, a user agent, a mobile client, a client, or some other suitable terminology.

In the example of FIG. 2, the hardware configuration 200 includes a processing system 202 that includes one or more core processors 204a-204n. Each of the core processors may include one or more registers 206a-206n. For example, a first core processor 204a may include a first set of registers 206a. The first set of registers 206a may be accessible by the corresponding core processor 204a and an advanced peripheral bus (APB) driver 208 via an APB 210. The first set of registers 206a may include a plurality of 64-bit registers configured for activity monitoring (e.g., an activity monitor unit (AMU)) and/or performance monitoring (e.g., a performance monitor unit (PMU)). The AMU and/or PMU may monitor power use (e.g., a register value indicative of power consumed by the corresponding core processor 204a during execution of an instruction), clock cycle count (e.g., a register value indicative of a number of clock cycles between a first instruction and a second instruction of the set of instructions during which the core processor is idle), and other suitable counter values. That is, the first set of registers 206a may be configured to store counter values indicative of activity and performance parameters corresponding to the execution of instructions by the corresponding core processor 204a.

In certain aspects, the APB driver 208 is a master with access to the counter values of any one or more registers 206a-206n from any one or more core processors 204a-204n. The APB driver 208 may also be configured to read the counter values of the one or more registers 206a-206n based on a “per-core” active core signal. The active core signal 212 indicates which core processor 204a-204n is active, and triggers the APB driver 208 to fetch one or more register values from the registers of the active core processor.

In some examples, the APB driver 208 is configured to receive a hysteresis signal from a hysteresis timer 216 of an instruction per cycle (IPC) calculator 214. In some examples, the hysteresis timer 216 is a counter that is incremented every clock cycle (e.g., a clock cycle of a core processor 204a-204n), thereby providing a hysteresis signal to the APB driver 208 every clock cycle. It should be noted that in some examples, the hysteresis timer 216 is configurable, and may be adjusted to scale the frequency of the hysteresis signal to any suitable frequency. For example, the hysteresis timer 216 may provide a clock signal having a frequency that depends on the counter reaching a certain count value corresponding to a count of a number of clock cycles of a core processor 204a-204n. The frequency of the hysteresis signal may be configured to define a programming window indicative of how frequently the register values of the one or more registers 206a-206n of a corresponding core processor 204a-204n are fetched by the APB driver 208. For example, the hysteresis timer 216 may provide a binary signal (e.g., core processor 204a-204n clock signal or scaled clock signal) to the APB driver 208, where the frequency of that signal indicates how frequently the register values of a register 206a-206n of a corresponding core processor 204a-204n are fetched by the APB driver 208. For example, when the APB driver 208 receives a “1” signal (e.g., a high clock signal) from the hysteresis timer 216, the APB driver 208 fetches a register value corresponding to the active core indicated by the active core signal 212. In other words, the hysteresis timer 216 may provide a “read-enable” signal to the APB driver 208 that controls how often the APB driver 208 fetches a set of instruction from a register, and therefore, how often the IPC calculator 214 and DCD calculator 222 scale the processor clock.

The processing system 202 and the APB driver 208 may be configured to communicate data bi-directionally via the APB 210 (e.g., the bus module 110 of FIG. 1). In some configurations, the APB driver 208 is configured as a master of the APB 210. The APB driver 208 may then pass the fetched register values to the IPC calculator 214.

The IPC calculator 214 is configured to determine an “expected IPC” for executing a set of instructions based on the fetched register values. For example, the APB driver 208 may fetch a monitored power use and a clock cycle count from one or more of the first set of registers 206a, and provide the fetched values to the IPC calculator 214. The IPC calculator 214 receives the fetched values and calculates the expected IPC for executing one or more instructions of the set of instructions based on the fetched values. In some examples, the expected IPC can be determined based on vectors such as memory stall vectors and high activity vectors. For example, the core processor may include another set of registers which contain values indicating a number of gaps of time between executing instructions (e.g., memory stalls) or how many times an executed instruction has drawn an amount of power that is greater than a threshold.

The IPC calculator 214 can then utilize a comparator 220 configured to compare the expected IPC to a “threshold IPC” to determine whether the expected IPC is less than the threshold IPC. In some examples, the threshold IPC is a value stored in a register 218 of the IPC calculator, where the stored value is indicative of an average number of instructions executed by a core processor (e.g., the first core processor 204a) each clock cycle. By comparing the expected IPC with the threshold IPC, the IPC calculator 214 may determine if a system clock frequency of the active core processor (e.g., a clock frequency used by the active core processor to execute an instruction) should be scaled to reduce the amount of power used by the core processor in executing the instruction.

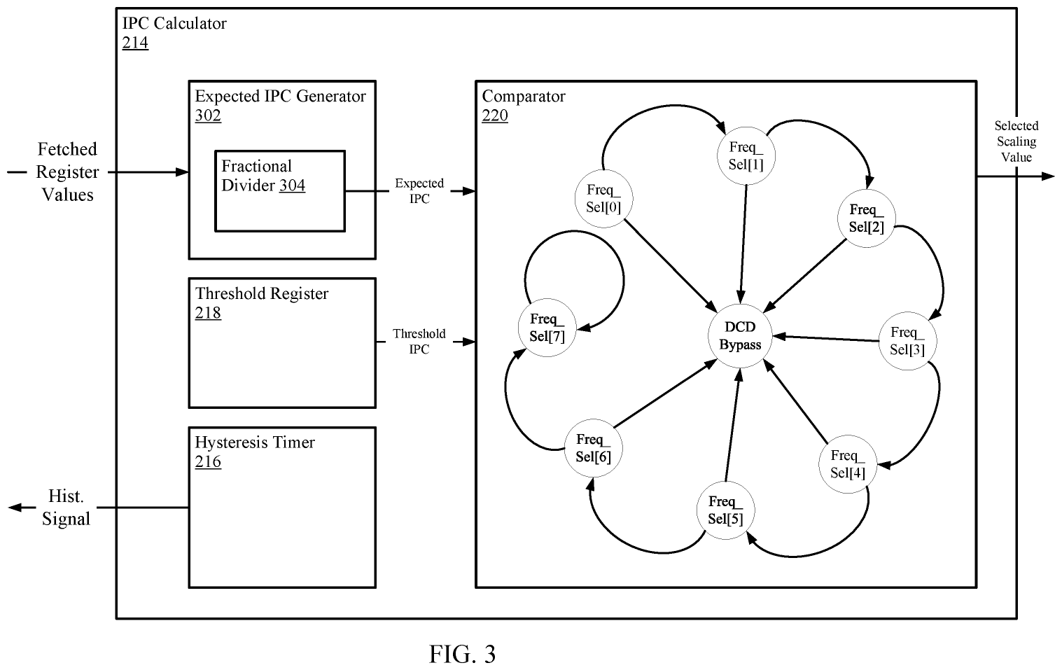

In certain aspects, the IPC calculator 214 selects a frequency scaling value, and outputs the scaling value to a clock generator, (e.g., a differential clock divider (DCD) calculator 222). This process is described in more detail below in reference to FIG. 3.

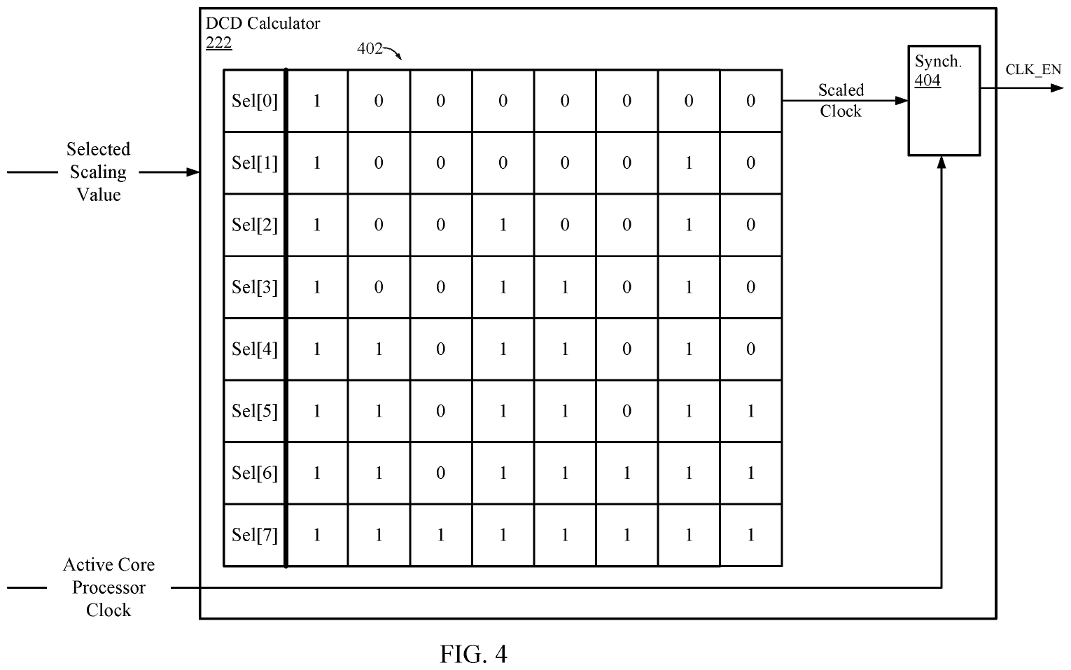

The DCD calculator 222 may then scale the system clock frequency of the active core processor based on the selected scaling value. This process is described in more detail below in reference to FIG. 4. It should be noted that in certain configurations, each of the core processors 206a-206n may include a dedicated IPC calculator 214 and DCD calculator 222 separate from other IPC calculators and DCD calculators dedicated to other core processors.

FIG. 3 is a block diagram illustrating an example implementation of the IPC calculator 214. In some examples, IPC calculator 214 may include an expected IPC generator 302, the hysteresis timer 216, the threshold register 218, and the comparator 220. The fractional divider 304 may be configured to calculate the expected IPC by performing mathematical functions using the fetched register values. For example, the fractional divider 304 may calculate the expected IPC by dividing a first fetched register value with a second fetched register value.

In certain aspects, the comparator 220 may receive the calculated expected IPC and the stored threshold IPC. In a step process, the comparator 220 may cycle iteratively through a graduated series of frequency scaling values (e.g., Freq_sel[0]-Freq_sel[7], where Freq_sel[0] provides a minimum scaling of the system clock frequency, and Freq_sel[7] provides a maximum scaling of the system clock frequency) based on whether a comparison of the expected IPC and the stored IPC satisfies an equality condition. For example, Freq_sel[0] may provide a minimum scaling by reducing, or “muting” relatively more clock pulses than other frequency scaling values. As such, the resultant clock is scaled to allow only a minimum number of clock pulses. In the example illustrated in FIG. 4, Freq_sel[0] only allows a single clock pulse, whereas Freq_sel[1] through Freq_sel[7] allow relatively more clock pulses. In another example, Freq_sel[7] provides a maximum scaling by allowing relatively more clock pulses than other frequency scaling values (e.g., muting no clock pulses, or relatively fewer clock pulses).

Initially, when comparing the expected IPC to the threshold IPC, if the comparator 220 determines that the expected IPC is less than the threshold IPC, then the comparator 220 selects Freq_sel[0], and the IPC calculator 214 outputs a signal (e.g., selected scaling value) indicating the Freq_sel[0] scaling value to the DCD calculator 222. The DCD calculator 222 then outputs a clock enable (CLK_EN) signal to the active core processor, wherein the CLK-EN signal is configured to scale the system clock frequency of the active core processor based on matrix values corresponding to Freq_sel[0]. For example, the system clock may only be enabled if the CLK_EN signal is high.

The active core processor (e.g., core processor 204a) then executes the instruction using the scaled system clock frequency, and updates one or more values in the set of registers 206a values accordingly. The next time the instruction is to be executed, the APB driver 208 fetches the updated register values and provides them to the IPC calculator 214. The IPC calculator 214 again calculates a new expected IPC based on the updated register values, and compares the new expected IPC to the stored threshold IPC. If the new expected IPC is still less than the threshold IPC, then the comparator 220 moves to the next scaling value, selecting Freq_sel[1], and the IPC calculator 214 outputs a signal indicating Freq_sel[1] to the DCD calculator 222. This step process continues until the comparator 220 determines that the expected IPC is greater than the threshold IPC, or until the last step (e.g., Freq_sel[7]) is reached.

Because Freq_sel[7] is the last stored scaling value, once it is reached, the next time the instruction is to be executed, the APB driver 208 fetches the updated register values and provides them to the IPC calculator 214. The IPC calculator 214 again calculates a new expected IPC based on the updated register values, and compares the new expected IPC to the stored threshold IPC. If the new expected IPC is still less than the threshold IPC, then the comparator 220 will reuse Freq_sel [7], and the IPC calculator 214 will output a signal indicating Freq_sel[7] to the DCD calculator 222.

If the IPC calculator 214 determines that the expected IPC is greater than the threshold IPC, then the IPC calculator 214 will perform a DCD bypass procedure, and the core processor will execute the instruction at a full clock speed (e.g., no clock scaling).

FIG. 4 is a block diagram illustrating an example implementation of the DCD calculator 222. In some examples, the DCD calculator 222 may include a configurable matrix 402 and a synchronization component 404. The synchronization component 404 may be implemented by a flip-flop or other suitable hardware. In some examples, the synchronization component 404 is configured to receive a scaled clock frequency according to a selected entry in the matrix 402, and an active core processor clock signal. The synchronization component 404 may be configured to synchronize the scaled clock frequency with the active core processor clock signal to produce the CLK_EN signal, and output the CLK_EN signal to the active core processor.

The matrix 402 of the DCD calculator 222 includes a configurable number of rows and columns, wherein each row of the matrix 402 corresponds to a clock frequency scaling value (e.g., Sel[0]-Sel[7]). It should be noted that the number of rows and columns of the matrix 402 illustrated in FIG. 4 is exemplary and should not be understood to limit the scope of the DCD calculator 222 or matrix 402. In some examples, each column may be understood to correspond to a cycle (per number of columns of cycles, which repeat) of the active core processor clock signal, where a “1” indicates that the corresponding clock cycle is “allowed” or is expressed, and where a “0” indicates that the corresponding clock cycle is “muted” or suppressed. For example, scaling value Sel[5] may be configured to scale the active core processor clock signal by allowing a first two active core processor clock cycles, muting a third clock cycle, allowing fourth and fifth clock cycles, muting a sixth clock cycle, and allowing seventh and eighth clock cycles. In other examples within the scope of the present disclosure, the DCD calculator 222 may include a plurality of matrices, wherein each matrix of the plurality of matrices corresponds to one or more of the plurality of core processors 204a-204n. In one example, the DCD calculator 222 may include a separate matrix corresponding to each core processor 204a-204n. In another example, each matrix may correspond to one or more core processors 204a-204n.

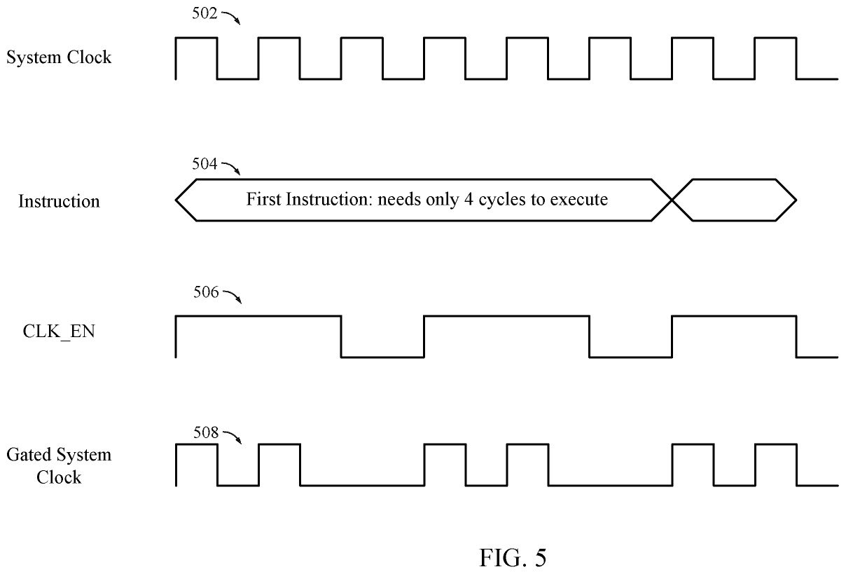

FIG. 5 illustrates an example clock signal waveform. In this example, a system clock waveform 502 is illustrated in a top row, showing a frequency of the active core processor (e.g., core processor 204a). Below the system clock waveform 502 is an instruction waveform 504 showing a duration for executing the instruction relative to the system clock. Below the instruction waveform 504 is a CLK_EN waveform 506 output from the synchronization component 404. Below the CLK_EN waveform 506 is a gated system clock waveform 508 showing a system clock of a corresponding core processor scaled according to the CLK_EN signal.

In one example, a first instruction may only require only 4 clock cycles to execute, but the expected IPC may indicate that the first instruction requires 6 clock cycles. In this example, the comparator 220 may compare the expected IPC to a stored threshold IPC, cycling through frequency scaling values until the expected IPC is greater than the threshold IPC or until the last scaling value is reached.

As shown in the FIG. 5, the comparator 220 has provided the DCD calculator 222 with a selected scaling value corresponding to Sel[5] of the matrix 402. The matrix 402 then provides a scaled clock signal to the synchronization component 404. The synchronization component 404 provides the CLK_EN signal output to the active core processor based on the scaled clock signal and the system clock of the active core processor. As shown in this example, every third clock signal is suppressed. Accordingly, the instruction is executed using only 4 clock cycles instead of 6 clock cycles.

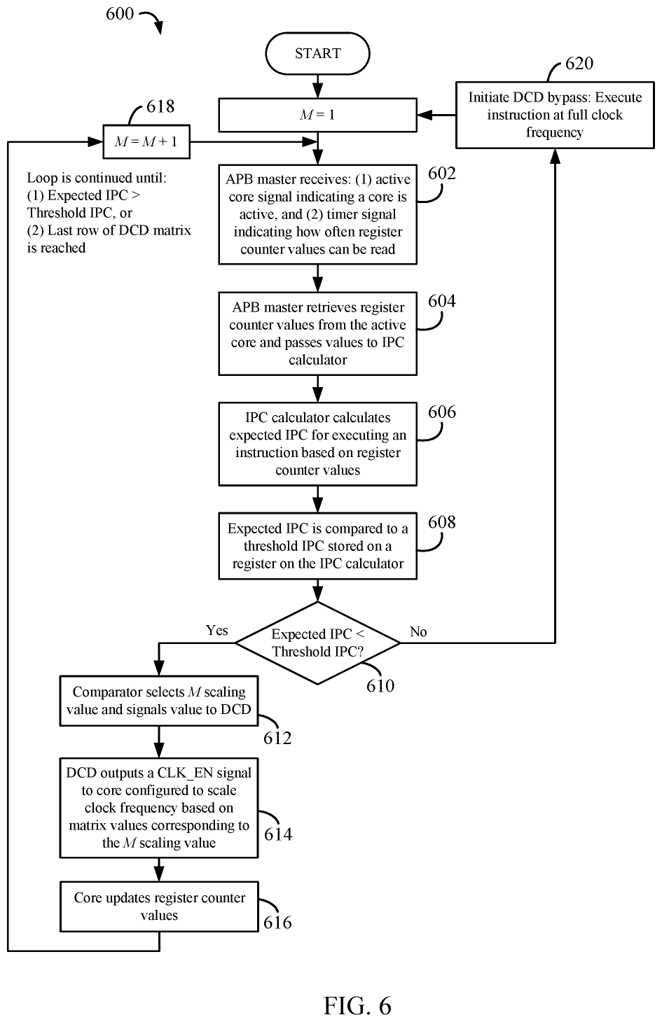

FIG. 6 is a flow diagram illustrating example operations 600 for scaling a system clock of an active core processor. Aspects of the operations 600 may be performed, for example, by hardware on a processing system (e.g., such as the processing system 120 of the SoC 100 in FIG. 1). Aspects of the operations 600 may be implemented as software components that are executed and run on one or more processors (e.g., CPU 102, DSP 104, or application processor 106 of FIG. 1). In certain aspects, the transmission and/or reception of data by various hardware components may be implemented via a bus interface (e.g., bus module 110 of FIG. 1).

Initially, at a first step 602, an APB driver (e.g., APB driver 208 of FIG. 2) may receive: (i) an active core signal indicating that a core processor (e.g., core processor 204a) is active, and (ii) a timer signal (e.g., hysteresis timer signal from the hysteresis timer 216 of FIG. 2) indicating how often the APB driver 208 can read counter values of one or more registers (e.g., the one or more registers 206a of FIG. 2) of the active core processor.

At a second step 604, the APB driver 208 may retrieve a first value from a first register of the core processor 204a and a second value from a second register of the core processor 204a, wherein the first value and the second value correspond to a set of instructions to be executed by the core processor 204a. The first value and the second value may provide any suitable information about the core processor and the set of instructions. In one example, the first value is indicative of a clock cycle count (e.g., a number of clock cycles between a first instruction and a second instruction of the set of instructions during which the core processor is idle, or a number of system clock cycles over a duration of time), and the second value is indicative of a number of instructions executed during the clock cycle count, or indicative of power consumed by the corresponding core processor during execution of an instruction. In certain aspects, the APB driver 208 may pass the retrieved values to an IPC calculator (e.g., IPC calculator 214 of FIG. 2).

At a third step 606, the IPC calculator 214 calculates an expected IPC for executing an instruction, where the expected IPC is calculated using the first value and the second value retrieved from the first register and the second register of the core processor 204a.

At a fourth step 608, the IPC calculator 214 compares a stored threshold IPC to the expected IPC to determine whether an equality condition is met, wherein the threshold IPC is stored in a third register of the IPC calculator. In some examples, the equality condition is not met if the expected IPC is less than the threshold IPC.

At a fifth step 610, the IPC calculator 214 may determine that the threshold condition is not met (e.g., the expected IPC is less than the threshold IPC).

If the threshold condition is not met, then the operations may proceed to a sixth step 612, where the IPC calculator 214 determines an initial scaling value of a plurality of scaling values. In this example, each of the plurality of scaling values may correspond to an M value indicative of an index of each respective scaling value. In this example, the initial scaling value is indexed as 1, and thus, M is initially equal to 1. In some examples, the scaling values are indexed such that the initial scaling value (e.g., M=1) is configured to scale the system clock cycle signal by fewer clock cycles relative to another scaling value (e.g., M>1). The IPC calculator 214 may signal the initial scaling value to a DCD calculator (e.g., DCD calculator 222 of FIG. 4).

At a seventh step 614, the DCD calculator 222 may scale the system clock cycle signal of the core processor 204a according to the initial scaling value. For example, the DCD calculator 222 may output a CLK_EN signal to the core processor 204a, wherein the CLK_EN signal is configured to scale the system clock cycle signal according to the initial scaling value.

At an eighth step 616, the core processor 204a updates its register counter values based on the execution of the instruction. For example, the core processor 204a may update the first register with a third value, and update the second register with a fourth value.

At a ninth step 618, the IPC calculator 214 increments M.

If the IPC calculator 214 determines that the threshold condition is met (e.g., expected IPC calculator 214 determines that the expected IPC is greater than or equal to the threshold IPC) at the fifth step 610, then the operations may proceed to a tenth step 620, where the core processor 204a executes the set of instructions using the system clock cycle signal (e.g., the system clock cycle signal is not scaled).

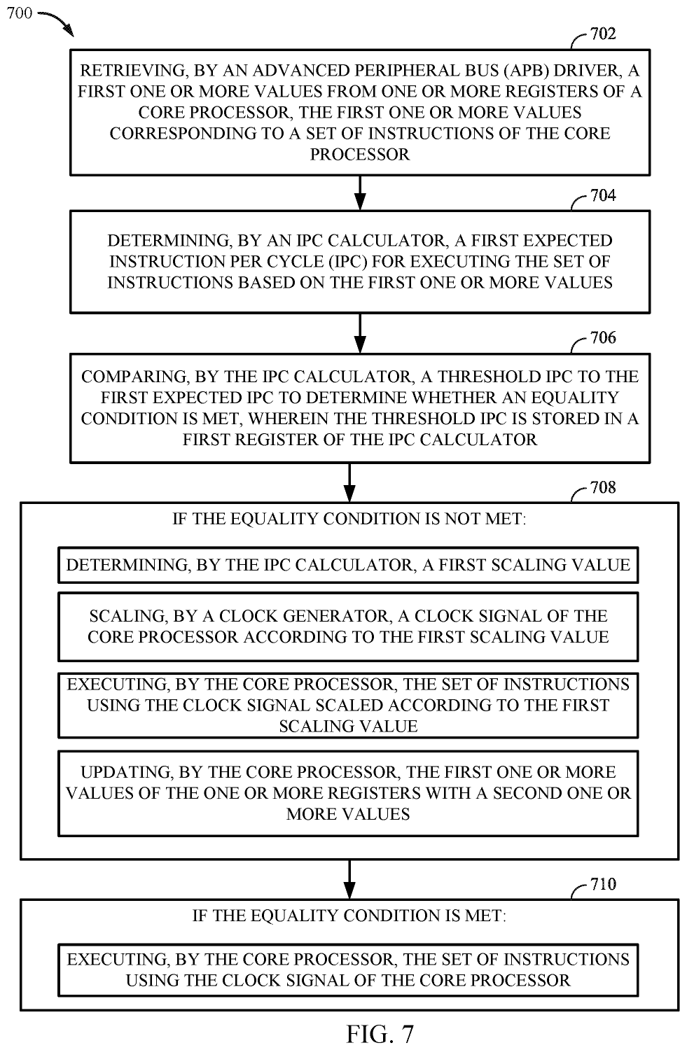

FIG. 7 is a flow diagram illustrating example operations 700 for scaling a core processor clock signal. Aspects of the operations 700 may be performed, for example, by hardware on a processing system (e.g., such as the processing system 120 of the SoC 100 in FIG. 1). Aspects of the operations 700 may be implemented as software components that are executed and run on one or more processors (e.g., CPU 102, DSP 104, or application processor 106 of FIG. 1). In certain aspects, the transmission and/or reception of data by various hardware components may be implemented via a bus interface (e.g., bus module 110 of FIG. 1).

The operations 700 may begin, at block 702, by retrieving, by an advanced peripheral bus (APB) driver, a first one or more values from one or more registers of a core processor, the first one or more values corresponding to a set of instructions of the core processor.

The operations 700 proceed to block 704 by determining, by an IPC calculator, a first expected instruction per cycle (IPC) for executing the set of instructions based on the first one or more values.

The operations 700 proceed to block 706 by comparing, by the IPC calculator, a threshold IPC to the first expected IPC to determine whether an equality condition is met, wherein the threshold IPC is stored in a first register of the IPC calculator.

The operations 700 may proceed to block 708, wherein if the equality condition is not met, the operations 700 are configured for determining, by the IPC calculator, a first scaling value, scaling, by a clock generator, a clock signal of the core processor according to the first scaling value, executing, by the core processor, the set of instructions using the clock signal scaled according to the first scaling value, and updating, by the core processor, the first one or more values of the one or more registers with a second one or more values.

The operations 700 may proceed to block 710, wherein if the equality condition is met, the operations 700 are configured for executing, by the core processor, the set of instructions using the clock signal of the core processor.

In certain aspects, operations 700 may include retrieving, by the APB driver, the second one or more values from the one or more registers. The operations 700 may also include determining, by the IPC calculator, a second expected IPC for executing the set of instructions based on the second one or more values. The operations 700 may also include comparing, by the IPC calculator, the threshold IPC to the second expected IPC to determine whether the equality condition is met.

If the equality condition is not met, the operations 700 may also include determining, by the IPC calculator, a second scaling value. The operations 700 may also include scaling, the clock generator, the clock signal of the core processor according to the second scaling value. The operations 700 may also include executing, by the core processor, the set of instructions using the clock signal scaled according to the second scaling value. The operations 700 may also include updating, by the core processor, the second one or more values of the one or more registers with a third one or more values.

If the equality condition is met, executing, by the core processor, the set of instructions using the clock signal of the core processor.

In certain aspects, the operations 700 include iteratively selecting the first scaling value and the second scaling value from a set of stored scaling values, wherein each of the stored scaling values in the set of scaling values correspond to an entry in a stored matrix.

In certain aspects, the operations 700 include retrieving, by the APB driver, the third one or more values from the one or more registers. The operations 700 may also include determining, by the IPC calculator, that the second scaling value is the last scaling value of the set of stored scaling values. The operations 700 may also include determining, by the IPC calculator, to reuse the second expected IPC for executing the set of instructions based on the third one or more values and the determination that the second scaling value is the last scaling value.

In certain aspects, the stored matrix comprises a plurality of rows and a plurality of columns, wherein each of the plurality of rows corresponds to one of the set of stored scaling values, and wherein each of the plurality of columns corresponds to one clock cycle of a contiguous series of clock cycles of the clock signal of the core processor.

In certain aspects, each of the plurality of columns is configured to indicate one of an expression or a suppression for each clock cycle of the contiguous series of clock cycles.

In certain aspects, the one or more values comprise a first value and a second value, the first value indicative of a count of a number of clock cycles over a period of time, the second value indicative of a count of instructions executed over the period of time, and determining the first expected IPC further comprises dividing the second value by the first value.

In certain aspects, the one or more registers comprise a first register and a second register, the first register and the second register comprise an active monitor unit (AMU) register or a performance monitor unit (PMU) register, the AMU is configured to gather power data associated with the core processor, and the PMU is configured to gather one or more of operational data or memory data associated with the core processor.

In certain aspects, each of the first value and the second value are indicative of at least a memory stall count or an activity count, the memory stall count is indicative of a number of clock cycles between a first instruction and a second instruction of the set of instructions during which the core processor is idle, and the activity count is indicative of power consumed by the core processor during execution of the first instruction.

In certain aspects, the operations 700 may also include receiving, by the APB driver, an active signal from the core processor indicating that the core processor is active, wherein retrieving the one or more values further comprises retrieving a first value from the first register and a second value from the second register in response to receiving the active signal.

In certain aspects, the first expected IPC is determined by dividing the first value by the second value.

In certain aspects, the clock generator is a differential clock divider (DCD) calculator comprising a separate configurable matrix for each core processor of a plurality of core processors.

### Additional Considerations

In some configurations, the term(s) ‘communicate,’ ‘communicating,’ and/or ‘communication’ may refer to ‘receive,’ ‘receiving,’ ‘reception,’ and/or other related or suitable aspects without necessarily deviating from the scope of the present disclosure. In some configurations, the term(s) ‘communicate,’ ‘communicating,’ ‘communication,’ may refer to ‘transmit,’ ‘transmitting,’ ‘transmission,’ and/or other related or suitable aspects without necessarily deviating from the scope of the present disclosure.

Within the present disclosure, the word “exemplary” is used to mean “serving as an example, instance, or illustration.” Any implementation or aspect described herein as “exemplary” is not necessarily to be construed as preferred or advantageous over other aspects of the disclosure. Likewise, the term “aspects” does not require that all aspects of the disclosure include the discussed feature, advantage or mode of operation. The term “coupled” is used herein to refer to the direct or indirect coupling between two objects. For example, if object A physically touches object B, and object B touches object C, then objects A and C may still be considered coupled to one another—even if they do not directly physically touch each other. For instance, a first object may be coupled to a second object even though the first object is never directly physically in contact with the second object. The terms “circuit” and “circuitry” are used broadly, and intended to include both hardware implementations of electrical devices and conductors that, when connected and configured, enable the performance of the functions described in the present disclosure, without limitation as to the type of electronic circuits.

One or more of the components, steps, features and/or functions illustrated herein may be rearranged and/or combined into a single component, step, feature or function or embodied in several components, steps, or functions. Additional elements, components, steps, and/or functions may also be added without departing from novel features disclosed herein. The apparatus, devices, and/or components illustrated herein may be configured to perform one or more of the methods, features, or steps described herein. The novel algorithms described herein may also be efficiently implemented in software and/or embedded in hardware.

It is to be understood that the specific order or hierarchy of steps in the methods disclosed is an illustration of exemplary processes. Based upon design preferences, it is understood that the specific order or hierarchy of steps in the methods may be rearranged. The accompanying method claims present elements of the various steps in a sample order, and are not meant to be limited to the specific order or hierarchy presented unless specifically recited therein.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but are to be accorded the full scope consistent with the language of the claims, wherein reference to an element in the singular is not intended to mean “one and only one” unless specifically so stated, but rather “one or more.” Unless specifically stated otherwise, the term “some” refers to one or more. A phrase referring to “at least one of” a list of items refers to any combination of those items, including single members. As an example, “at least one of: a, b, or c” is intended to cover: a; b; c; a and b; a and c; b and c; and a, b and c. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112(f) unless the element is expressly recited using the phrase “means for” or, in the case of a method claim, the element is recited using the phrase “step for” or simply as a “block” illustrated in a figure.

These apparatus and methods described in the detailed description and illustrated in the accompanying drawings by various blocks, modules, components, circuits, steps, processes, algorithms, etc. (collectively referred to as “elements”). These elements may be implemented using hardware, software, or combinations thereof. Whether such elements are implemented as hardware or software depends upon the particular application and design constraints imposed on the overall system.

By way of example, an element, or any portion of an element, or any combination of elements may be implemented with a “processing system” that includes one or more processors. Examples of processors include microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software modules, applications, software applications, software packages, firmware, routines, subroutines, objects, executables, threads of execution, procedures, functions, etc., whether referred to as software, firmware, middleware, microcode, hardware description language, or otherwise. The software may be stored on non-transitory computer-readable medium included in the processing system.

Accordingly, in one or more exemplary embodiments, the functions described may be implemented in hardware, software, or combinations thereof If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise RAM, ROM, EEPROM, PCM (phase change memory), flash memory, CD-ROM or other optical disk storage, magnetic disk storage or other magnetic storage devices, or any other medium that can be used to carry or store desired program code in the form of instructions or data structures and that can be accessed by a computer. Disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer-readable media.

What is claimed is:

1. A method for dynamically scaling a clock frequency, comprising:
retrieving, by an advanced peripheral bus (APB) driver, a first one or more values from one or more registers of a core processor, the first one or more values corresponding to a set of instructions of the core processor;
determining, by an IPC calculator, a first expected instruction per cycle (IPC) for executing the set of instructions based on the first one or more values;
comparing, by the IPC calculator, a threshold IPC to the first expected IPC to determine whether an equality condition is met, wherein the threshold IPC is stored in a first register of the IPC calculator;
if the equality condition is not met:
determining, by the IPC calculator, a first scaling value;
scaling, by a clock generator, a clock signal of the core processor according to the first scaling value;
executing, by the core processor, the set of instructions using the clock signal scaled according to the first scaling value; and
updating, by the core processor, the first one or more values of the one or more registers with a second one or more values; and
if the equality condition is met, executing, by the core processor, the set of instructions using the clock signal of the core processor.

2. The method of claim 1, further comprising:
retrieving, by the APB driver, the second one or more values from the one or more registers;
determining, by the IPC calculator, a second expected IPC for executing the set of instructions based on the second one or more values;
comparing, by the IPC calculator, the threshold IPC to the second expected IPC to determine whether the equality condition is met;
if the equality condition is not met:
determining, by the IPC calculator, a second scaling value;
scaling, the clock generator, the clock signal of the core processor according to the second scaling value;
executing, by the core processor, the set of instructions using the clock signal scaled according to the second scaling value; and
updating, by the core processor, the second one or more values of the one or more registers with a third one or more values; and
if the equality condition is met, executing, by the core processor, the set of instructions using the clock signal of the core processor.

3. The method of claim 2, further comprising iteratively selecting the first scaling value and the second scaling value from a set of stored scaling values, wherein each of the stored scaling values in the set of scaling values correspond to an entry in a stored matrix.

4. The method of claim 3, further comprising:
retrieving, by the APB driver, the third one or more values from the one or more registers;
determining, by the IPC calculator, that the second scaling value is the last scaling value of the set of stored scaling values; and
determining, by the IPC calculator, to reuse the second expected IPC for executing the set of instructions based on the third one or more values and the determination that the second scaling value is the last scaling value.

5. The method of claim 3, wherein the stored matrix comprises a plurality of rows and a plurality of columns, wherein each of the plurality of rows corresponds to one of the set of stored scaling values, and wherein each of the plurality of columns corresponds to one clock cycle of a contiguous series of clock cycles of the clock signal of the core processor.

6. The method of claim 5, wherein each of the plurality of columns is configured to indicate one of an expression or a suppression for each clock cycle of the contiguous series of clock cycles.

7. The method of claim 1, wherein:
the one or more values comprise a first value and a second value;
the first value indicative of a count of a number of clock cycles over a period of time;
the second value indicative of a count of instructions executed over the period of time; and
determining the first expected IPC further comprises dividing the second value by the first value.

8. The method of claim 1, wherein:
the one or more registers comprise a first register and a second register;
the first register and the second register comprise an active monitor unit (AMU) register or a performance monitor unit (PMU) register;
the AMU is configured to gather power data associated with the core processor; and
the PMU is configured to gather one or more of operational data or memory data associated with the core processor.

9. The method of claim 8, wherein:
each of the first value and the second value are indicative of at least a memory stall count or an activity count;
the memory stall count is indicative of a number of clock cycles between a first instruction and a second instruction of the set of instructions during which the core processor is idle; and
the activity count is indicative of power consumed by the core processor during execution of the first instruction.

10. The method of claim 1, further comprising receiving, by the APB driver, an active signal from the core processor indicating that the core processor is active, wherein retrieving the one or more values further comprises retrieving a first value from the first register and a second value from the second register in response to receiving the active signal.

11. The method of claim 10, wherein the first expected IPC is determined by dividing the first value by the second value.

12. The method of claim 1, wherein the clock generator is a differential clock divider (DCD) calculator comprising a separate configurable matrix for each core processor of a plurality of core processors.

13. An apparatus, comprising:
a memory; and
a processor communicatively coupled to the memory, the processor configured to:
retrieve a first one or more values from one or more registers of a core processor, the first one or more values corresponding to a set of instructions of the core processor;
determine a first expected instruction per cycle (IPC) for executing the set of instructions based on the first one or more values;
compare a threshold IPC to the first expected IPC to determine whether an equality condition is met, wherein the threshold IPC is stored in a first register of an IPC calculator;
if the equality condition is not met, the processor is further configured to:
determine a first scaling value;
scale a clock signal of the core processor according to the first scaling value;
execute the set of instructions using the clock signal scaled according to the first scaling value; and
update the first one or more values of the one or more registers with a second one or more values; and
if the equality condition is met, the processor is further configured to execute the set of instructions using the clock signal of the core processor.

14. The apparatus of claim 13, wherein the processor is further configured to:
retrieve the second one or more values from the one or more registers;
determine a second expected IPC for executing the set of instructions based on the second one or more values;
compare the threshold IPC to the second expected IPC to determine whether the equality condition is met;
if the equality condition is not met, the processor is further configured to:
determine a second scaling value;
scale the clock signal of the core processor according to the second scaling value;
execute the set of instructions using the clock signal scaled according to the second scaling value; and
update the second one or more values of the one or more registers with a third one or more values; and
if the equality condition is met, the processor is further configured to execute the set of instructions using the clock signal of the core processor.

15. The apparatus of claim 14, wherein the processor is further configured to iteratively select the first scaling value and the second scaling value from a set of stored scaling values, wherein each of the stored scaling values in the set of scaling values correspond to an entry in a stored matrix.

16. The apparatus of claim 15, wherein the processor is further configured to:
retrieve the third one or more values from the one or more registers;
determine that the second scaling value is the last scaling value of the set of stored scaling values; and
determine to reuse the second expected IPC for executing the set of instructions based on the third one or more values and the determination that the second scaling value is the last scaling value.

17. The apparatus of claim 15, wherein the stored matrix comprises a plurality of rows and a plurality of columns, wherein each of the plurality of rows corresponds to one of the set of stored scaling values, and wherein each of the plurality of columns corresponds to one clock cycle of a contiguous series of clock cycles of the clock signal of the core processor.

18. The apparatus of claim 17, wherein each of the plurality of columns is configured to indicate one of an expression or a suppression for each clock cycle of the contiguous series of clock cycles.

19. The apparatus of claim 13, wherein:
the one or more values comprise a first value and a second value;
the first value indicative of a count of a number of clock cycles over a period of time;
the second value indicative of a count of instructions executed over the period of time; and
the processor, being configured to determine the first expected instruction per cycle (IPC), is further configured to divide the second value by the first value.

20. The apparatus of claim 13, wherein:
the one or more registers comprise a first register and a second register;
the first register and the second register comprise an active monitor unit (AMU) register or a performance monitor unit (PMU) register;
the AMU is configured to gather power data associated with the core processor; and
the PMU is configured to gather one or more of operational data or memory data associated with the core processor.

21. The apparatus of claim 20, wherein:
each of the first value and the second value are indicative of at least a memory stall count or an activity count;
the memory stall count is indicative of a number of clock cycles between a first instruction and a second instruction of the set of instructions during which the core processor is idle; and
the activity count is indicative of power consumed by the core processor during execution of the first instruction.

22. The apparatus of claim 13, wherein the processor is further configured to receive an active signal from the core processor indicating that the core processor is active, wherein retrieving the one or more values further comprises retrieving a first value from the first register and a second value from the second register in response to receiving the active signal.

23. The apparatus of claim 22, wherein the first expected IPC is determined by dividing the first value by the second value.

24. An apparatus, comprising:
means for retrieving a first one or more values from one or more registers of a core processor, the first one or more values corresponding to a set of instructions of the core processor;
means for determining a first expected instruction per cycle (IPC) for executing the set of instructions first one or more values;
means for comparing a threshold IPC to the first expected IPC to determine whether an equality condition is met, wherein the threshold IPC is stored in a first register of an IPC calculator;
if the equality condition is not met:
means for determining a first scaling value;
means for scaling a clock signal of the core processor according to the first scaling value;
means for executing the set of instructions using the clock signal scaled according to the first scaling value; and
means for updating the first one or more values of the one or more registers with a second one or more values; and
if the equality condition is met, means for executing, by the core processor, the set of instructions using the clock signal of the core processor.

25. The apparatus of claim 24, further comprising:
means for retrieving the second one or more values from the one or more registers;
means for determining a second expected IPC for executing the set of instructions based on the second one or more values;
means for comparing the threshold IPC to the second expected IPC to determine whether the equality condition is met;
if the equality condition is not met:
means for determining a second scaling value;
means for scaling the clock signal of the core processor according to the second scaling value;
means for executing the set of instructions using the clock signal scaled according to the second scaling value; and
means for updating the second one or more values of the one or more registers with a third one or more values; and
if the equality condition is met, means for executing the set of instructions using the clock signal of the core processor.

26. The apparatus of claim 25, further comprising means for iteratively selecting the first scaling value and the second scaling value from a set of stored scaling values, wherein each of the stored scaling values in the set of scaling values correspond to an entry in a stored matrix.

27. The apparatus of claim 26, further comprising:
means for retrieving the third one or more values from the one or more registers;
means for determining that the second scaling value is the last scaling value of the set of stored scaling values; and
means for determining to reuse the second expected IPC for executing the set of instructions based on the third one or more values and the determination that the second scaling value is the last scaling value.

28. The apparatus of claim 26, wherein the stored matrix comprises a plurality of rows and a plurality of columns, wherein each of the plurality of rows corresponds to one of the set of stored scaling values, and wherein each of the plurality of columns corresponds to one clock cycle of a contiguous series of clock cycles of the clock signal of the core processor.

29. The apparatus of claim 28, wherein each of the plurality of columns is configured to indicate one of an expression or a suppression for each clock cycle of the contiguous series of clock cycles.

30. A non-transitory computer-readable storage medium that stores instructions that when executed by a processor of an apparatus cause the apparatus to perform a method for dynamically scaling a clock frequency, comprising:
retrieving a first one or more values from one or more registers of a core processor, the first one or more values corresponding to a set of instructions of the core processor;
determining a first expected instruction per cycle (IPC) for executing the set of instructions based on the first one or more values;
comparing a threshold IPC to the first expected IPC to determine whether an equality condition is met, wherein the threshold IPC is stored in a first register of an IPC calculator;
if the equality condition is not met:
determining a first scaling value;
scaling a clock signal of the core processor according to the first scaling value;
executing the set of instructions using the clock signal scaled according to the first scaling value; and
updating the first one or more values of the one or more registers with a second one or more values; and
if the equality condition is met, executing the set of instructions using the clock signal of the core processor.
